(19) United States
(12) Patent Application Publication
(10) Pub. No.: US 2007/0214247 A1
(43) Pub. Date: Sep. 13, 2007

(54) System for spatial backoff contention resolution for wireless networks

(76) Inventors: Xue Yang, Hillsboro, OR (US); Nitin H. Vaidya, Champaign, IL (US)

Correspondence Address: BRINKS HOFER GILSON & LIONE, P.O. BOX 10395, CHICAGO, IL, 60610, US

(21) Appl. No.: 11/375,609

(22) Filed: Mar. 13, 2006

(51) Int. Cl. G06F 15/173

(52) U.S. Cl. 709/223

(57) ABSTRACT

Spatial backoff methods allow source stations to search for appropriate carrier sense threshold and transmission rate operating points to improve network aggregate throughput. In one method, each source station performs a search process to find the best carrier sense threshold and transmission rate, based on a defined utility function. In a second method, each source station dynamically adjusts its carrier sense threshold and transmission rate upon successful transmissions or failures, based on some heuristic measures. Spatial backoff methods may lead to gains in performance.

### FEDERALLY SPONSORED RESEARCH OR DEVELOPMENT

This invention was made with Government support under Contract Number ANI-0125859 awarded by the National Science Foundation (NSF) and Contract Number W911NF-05-1-0246 awarded by the Defense Advanced Research Projects Agency (DARPA). The Government has certain rights in the invention.

### BACKGROUND OF THE INVENTION

1. Technical Field

The invention relates to data transmissions in wireless networks. In particular, the invention relates to network contention resolution in dense wireless networks.

2. Related Art

Medium access control (MAC) in networks has taken the set of competing stations as a given. A station may adjust its channel access behavior (e.g., using temporal backoff), so that transmissions from different stations may be separated in time to achieve successful transmissions. This is a temporal approach to resolve channel contention.

The “space” occupied while contending for channel access may depend in part on the transmission power used, data rate of transmission, carrier sense threshold of nodes, and other parameters. Different choices may be made to adjust the contending area. For a node S, one a channel contention may be represented by a “contending area’” around S. Nodes located within the contending area of S compete for the channel access with node S in time. contention is the “local channel contention” of node S. Nodes outside of the contending area of S may have their transmissions overlapped in time with node S.

If the radio signal strength detected at a station is below a Carrier Sense Threshold CSth, the station may attempt to proceed. Given a fixed transmission power used by other stations, a node may transmit more aggressively using higher carrier sense threshold values. A higher carrier sense threshold may lead to a smaller contending area. Given a carrier sense threshold used by other stations, a lower transmission power may lead to a smaller contending area.

Notice that, when adjusting the contending area, the interference present in the network varies. For example, increasing the carrier-sense threshold (with a fixed transmission power) allows transmitters to be closer each other and causes more interference. Typically, the quality of a communication link depends on the interference at the receiver caused by other concurrent transmissions; the higher the Signal-to-Interference-and-Noise-Ratio (SINR), the higher the rate that packets can be transmitted reliably. To account for the change of interference, the transmission rate often needs to be adjusted along with the contending area. A smaller contending area often reduces the channel contention at the cost of poorer link quality.

One possible benefit of “spatial backoff” may be to improve the network aggregate throughput. From a MAC protocol point of view, the aggregate throughput depends on the MAC efficiency in resolving the “local” channel contention, the number of concurrent transmissions in the network, and the transmission rate between each transmitter/receiver pair. When transmitter density increases, a larger carrier sense threshold may be preferred to bring concurrent transmitters closer to each other. By doing this, the MAC efficiency in resolving the “local” channel contention can be improved due to the reduced number of competing stations and the reduced bandwidth-independent overhead. Since a lower bit rate may require less signal-to-noise-interference ratio (SINR), more interference can be tolerated at the receiver given a receiving signal strength. As a result, more concurrent transmissions can proceed and more spatial reuse can be exploited. The aggregate throughput can be improved due to the following two reasons: despite operating at a lower rate, each wireless link can be utilized more efficiently because a smaller fraction of channel capacity is wasted in MAC overhead; and more concurrent transmissions are allowed in the network. The increased aggregate throughput can result from more concurrent transmissions, even though the absolute rate of each individual link is lower.

The benefits of “spatial backoff” cannot be achieved by existing rate control protocols because changing transmission rate alone will not improve the spatial reuse. There is also some existing work on carrier sense threshold control to maximize the spatial reuse given a pre-defined transmission rate. However, such schemes are unable to fully explore the spatial reuse when transmission rate can be adjusted. Therefore, a need exists for a network contention resolution method that allows adjustment of both the transmission rate and carrier sense threshold.

### SUMMARY

Nodes in a wireless network may compete for “space” to schedule their packet transmissions, and the contending area around each node may be adjusted such that the channel contention may reach a desired level.

By modifying the carrier sense threshold and transmission rate control, the contending area is adjusted for a fixed transmission power used by all stations. When transmitter density increases, a smaller contending area may bring concurrent transmitters closer to each other. The MAC overhead in resolving the “local” channel contention may be reduced due to the reduced channel bit rate and the reduced number of competing stations. Spatial reuse may be improved since more concurrent transmissions are allowed to proceed. The aggregate throughout may be higher even though the transmitters may have to transmit at lower rates because of larger interference.

“Spatial backoff” methods may allow source stations to search for the appropriate carrier sense threshold and transmission rate operating points to improve the network aggregate throughput. Each transmitter may perform an exhaustive search process to find the best carrier sense threshold and transmission rate, based on a defined utility function. In a dynamic contention resolution method, each source station dynamically adjusts its carrier sense threshold and transmission rate upon successful transmissions or failures, based on some transmission success measure. Spatial backoff may lead to gains in performance.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates an example network with a number of transmitters.

FIG. 2 illustrates transmitter carrier sense ranges.

FIG. 3 illustrates an example process for resolving network contention.

FIG. 4 illustrates an example flow diagram for transmitter network contention states.

FIG. 5 illustrates an example process for dynamically resolving network contention.

FIG. 6 illustrates an example state graph for transmitter parameters.

FIG. 7 illustrates an example process for responding to unsuccessful transmissions.

FIG. 8 illustrates a second example process for dynamically resolving network contention.

### DETAILED DESCRIPTION OF THE PREFERRED EMBODIMENTS

Spatial backoff methods allow source stations to search for appropriate carrier sense threshold and transmission rate operating points to improve network aggregate throughput. For a given a carrier sense threshold CSth, the corresponding Carrier Sense Range D may be defined as the minimum distance allowed between two concurrent transmitters. A larger carrier sense threshold may lead to a smaller carrier sense range.

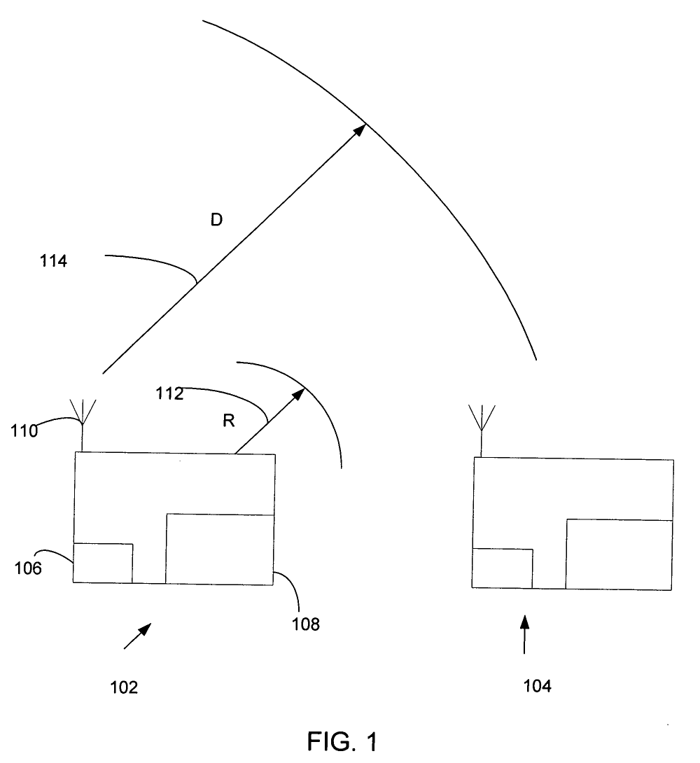

FIG. 1 illustrates a wireless network system 100. The network system 100 may include one or more transmitter stations, such as transmitters 102 and 104. The transmitters 102 and 104 may include receivers 106, secondary radio modules 108, and transmitting antennae 110. The transmitters 102 and 104 may be in a dense network system, where the transmitters 102 and 104 are located close to one another relative to their transmission ranges. The transmitters 102 and 104 may be uniformly and independently distributed in an area of A. A common and fixed transmission power P may be used by each transmitter 102 and 104. The minimum received signal strength that invokes the packet receiving procedure at a receiver may be defined as a Receiving Signal Threshold, denoted as RXth. Given the value of RXth, the Maximum Transmission Range R 112, which may be defined as the maximum possible distance between the transmitter and receiver, may be determined accordingly based on a radio propagation model. An achievable channel bit rate between the transmitter/receiver pair may depends on the Signal to Interference Noise Ratio (SINR) at the receiver, where transmitter 102 or 104 may be configurable as a receiver as well.

Two concurrent transmissions may occur only if the distance between the two transmitters is larger than the carrier sense range D 114. For a larger carrier sense range, less interference will be received and the SINR will be better at the receiver. Consequently, the wireless link between the transmitter/receiver pair may operate at a higher rate. A large carrier sense range may severely limit the aggregate throughput since each station may become too conservative in initiating a transmission and the number of concurrent transmissions may decrease.

When a transmitter 102 is transmitting, a concurrent transmission may happen only at a transmitter 104 that is distance D 110 away from the transmitter 102. Moreover, when transmitters 102 and 104 are transmitting at the same time, the next concurrent transmission may only come from stations that are distance D away from both transmitters 102 and 104.

Both MAC efficiency and spatial reuse may be increasing functions of carrier sense threshold. When applying a larger carrier sense threshold (i.e., a smaller carrier sense range), both the bandwidth-independent MAC overhead and the bandwidth-dependent MAC overhead will be reduced, which leads to improved MAC efficiency and better utilization of each individual wireless link.

When transmitter density in a network 100 increases, a larger carrier sense threshold may be preferred to bring transmitters closer to each other. The MAC efficiency may be improved and more concurrent transmissions may proceed. Even though each communication link may have to operate at a lower transmission rate, the aggregate throughput may be improved as long as there are sufficient transmitters 102 and 104 to exploit an available spatial reuse.

The optimal carrier sense threshold may depend on the network topology, the degree of channel contention and other factors affecting the bandwidth-dependent and bandwidth independent overheads. With an inappropriate choice of carrier sense threshold, the aggregate throughput may suffer a significant loss.

Utility-Based Spatial Back-Off Method

A spatial backoff process may provide a good combination of a carrier sense threshold and a transmission rate such that the network aggregate throughput may approach a maximum point. A utility measure may be defined as:
Uᵢ=rateᵢ*csᵢ^{2/θ}*p_{suc}_{ᵢ}

Where rateᵢ is the transmission rate, csᵢ is the carrier sense threshold used by station i, and p_{suci} is a transmission success probability, given the chosen csᵢ and Rindex.

θ is the path loss coefficient which may be determined empirically or derived analytically. CS^{2/θ} may quantify the number of concurrent transmissions that may be possibly allowed in the network, if all stations use the same carrier sense threshold.

The parameter p_{suci} may incorporate the impact of MAC efficiency on aggregate throughput. If the carrier sense threshold csᵢ is chosen to be too small, the contending area around station i may be too large. With a large number of competing stations, the packet success probability p_{suci} may be low, which may result in bad utility measures. The defined utility function U may help to maintain a suitable size for the contending area.

Given a fixed Rindex and p_{suci}, the utility is an increasing function of csᵢ, which may increase spatial reuse. If csᵢ is large, the interference may become very large and the SINR required by the chosen transmission rate may not be satisfied. As a result, p_{suci} may be very low and the utility measure may be poor.

Given a fixed csᵢ and p_{suci}, the utility is an increasing function of Rindex, which may allow a use of the highest transmission rate that can be supported by the SINR at the receiver. However, if station i chooses a high transmission rate, the required SINR may not be satisfied. Transmissions may fail and p_{suci} may be very low, leading to a poor utility measure.

The utility function defined above may be utilized for a dense network, in which there may be multiple transmitters 102 and 104 to exploit the available spatial reuse. When a station adjusts the level of carrier sense threshold it uses, it may change the interference it causes to other stations, which, in turn, may affect other station's choice of carrier sense threshold. Examples of dense networks include wireless networks such as IEEE 802.11 networks, cellular networks, wireless local area networks (LANs), or WiMax.

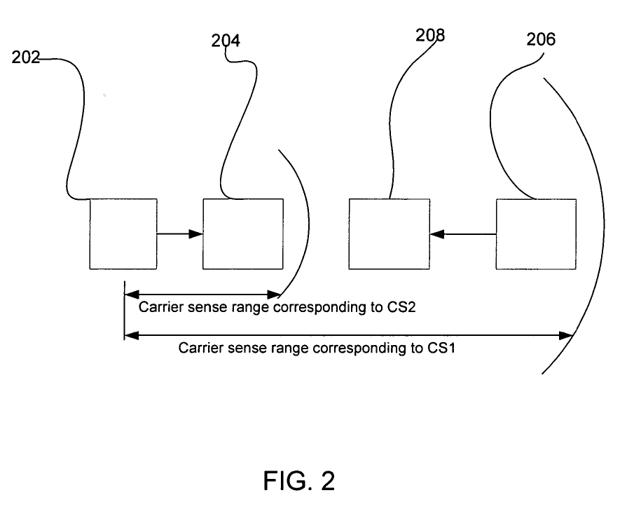

FIG. 2 illustrates a two transmitter configuration 200. There may be four stations 202, 204, 206, and 208 where transmitter 202 is transmitting to station 204, and transmitter 206 is transmitting to station 208. There are two different carrier sense threshold values, cs1 and cs2, that transmitters 202 and 206 may choose from. If cs1<cs2 and using cs1, the transmitter 202 may defer when the transmitter 206 is transmitting to avoid collisions, and vice versa. Transmitters 202 and 206 will transmit alternately, at some rate, say, R1, if they both use cs1. When using cs2, the transmitter 202 will transmit even though the transmitter 206 is transmitting. In a symmetric network, transmitters 202 and 206 will transmit concurrently at rate R2 if they both use cs2. When the transmitter 202 uses cs1 and transmitter 206 uses cs2, transmitter 202 may have to endure the large interference from transmitter 206, and at the same time, transmit less frequently. Transmitter 202 suffers performance loss and transmitter 206 may achieve more throughput. The situation is reversed when transmitter 202 uses cs2 and transmitter 206 uses cs1. The locations of the transmitters 202, 204, 206, and 208 may be chosen such that R2<R1/2. Then, in this example, the optimal carrier sense threshold for both transmitters 202 and 204 is cs1.

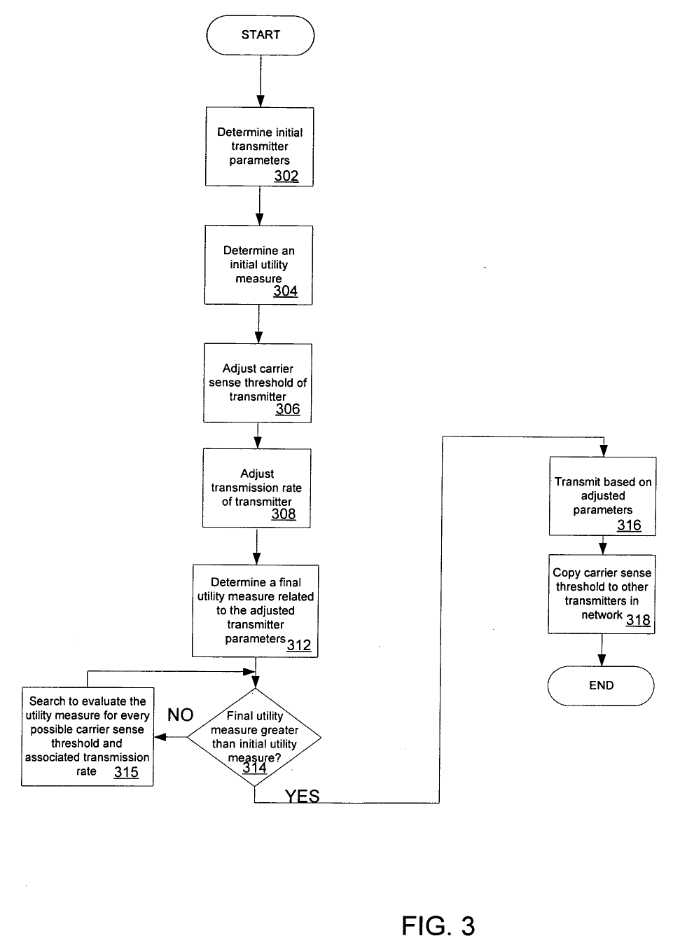

FIG. 3 illustrates a process for resolving network contention in a wireless network. In the utility-based spatial backoff process, each transmitter 102 performs a searching phase, during which a comparison is performed to find the carrier sense threshold that maximizes the utility. The transmitter 102 determines a plurality of initial transmitter station parameters by initializing parameters such as the transmission rate and the carrier sense threshold for the transmitter 102 (Act 302). The transmitter 102 may initialize other parameters as well, and may communication with other stations within the network. The transmitter 102 determines an initial utility measure of a wireless transmitter station related to the plurality of initial transmitter station parameters (Act 304). The utility measure may be calculated as:
Uᵢ=rateᵢ*csᵢ^{2/θ}*p_{suc}_{ᵢ} Eqn. 1

where rateᵢ is the transmission rate, csᵢ is the carrier sense threshold used by station i, and p_{suci} is a transmission success probability, given the chosen csᵢ and Rindex. The parameters Rindex, and csᵢ, may be initialized prior to operation, or may be dynamically selected.

The transmitter 102 adjusts, during a sampling period, a first transmitter parameter and a second transmitter parameter of the plurality of initial transmitter station parameters, such as the carrier sense threshold (Act 306) and the transmission rate (Act 308). The transmitter 102 may limit the transmission rate to a level no higher than a maximum transmitter transmission rate, which may be determined by the characteristics, dimensions, frequency performance range, or other criteria. The transmitter 102 may also limit the transmission rate to a minimum rate, such as a minimum transmitter transmission rate. This minimum rate may be determined by a required quality of service rate, frequency performance range, or bit performance criteria. The transmitter 102 may perform a transmission rate control procedure, such as an automatic rate fall-back procedure as part of the adjustment process. Given the carrier sense threshold used by the transmitter 102, there may exist a highest transmission rate that can be supported by the SINR at the receiver of the transmitter 102, which may be the most suitable transmission rate for the chosen carrier sense threshold. To allow the searching station to find such a transmission rate for each chosen carrier sense threshold, a rate control mechanism may be incorporated into the searching process. During each sampling period, if a predetermined number of consecutive transmissions are successful, such as ten, the searching station may increase the transmission rate by one level until the highest transmission rate is reached. The transmission rate may be decreased by one level until the lowest transmission rate is reached if a predetermined number of consecutive transmission attempts fail, such as three.

The transmitter 102 then determines a final utility measure related to the adjusted first and second transmitter parameters and a transmission success measure, such as a measure probability of successful transmission (Act 312). The transmitter 102 may use a utility measure such as Eqn. 1. The final utility measure is based on the same function as the initial utility measure. The final utility measure will be determined based on the adjusted carrier sense threshold, adjusted transmission rate, and transmission success measure, with a goal of maximizing the utility measure for the transmitter 102.

The transmitter 102 then compares the initial utility measure with the final utility measure to determine if the final utility measure is greater than the initial utility measure (Act 314). The transmitter 102 searches to evaluate the utility measure for every possible carrier sense threshold and associated transmission rate to maximize the utility measure (Act 315). The transmitter 102 transmits a data stream based on the initial transmitter station parameters if the initial utility measure is greater than the final utility measure and transmits a data stream based on the final, adjusted, transmitter station parameters if the final utility measure if greater than the final utility measure, such that the final utility measure represents the maximum utility measure obtained after completing the search of all possible carrier sense threshold and transmission rate combinations. (Act 316). The transmitter 102 may repeat the adjustment process until a predetermined number of iterations has been reached, or a predetermined criteria for the difference between the initial and final utility measure has been achieved.

The transmitter 102 may copy, to one or more interfering stations, the carrier sense threshold determined by the transmitter station (Act 318). The transmitter 102 may initialize a second radio transmitter associated with the transmitter station. The transmitter 102 may transmit, by the second radio transmitter, the carrier sense threshold adopted by the transmitter 102 during the search phase, to the one or more interfering stations. The second radio may have a transmission range of a distance at least as far as a distance of a farthest interfering station from the transmitting station. The transmitter 102 may need to reach all the interfering stations in the network 100. The interfering stations in the network 100 may then adopt the carrier sense threshold transmitted by the second radio transmitter of the transmitter 102. To facilitate a longer transmission range for the second radio, the second radio may transmit at a very low rate and/or use a larger transmission power.

The transmitter 102 determines, during the searching phase, whether a predetermined number of data packet transmissions were successful. The transmitter 102 also determines whether a predetermined number of data packet transmissions were unsuccessful. In wireless communication, a MAC layer acknowledge mechanism may be used due to the unreliability of the channel. That is, at MAC layer, after transmitting a packet, the transmitter 102 expects the receiver to reply acknowledgement immediately. If the acknowledgement is not received within a timeout duration, the transmitter 102 may assume the previous transmission has failed and may retransmit the same packet. Therefore, for any number of packets that have been transmitted, the transmitter 102 determines how many of them have failed and how many of them have succeeded.

The searching phase may consist of multiple sampling periods. At the same time, other source stations that are within an “interference range” of the searching station may be required to use the same carrier sense threshold as the searching station. After evaluating different choices of carrier sense threshold, the searching station chooses the one that generates the highest utility for itself.

The total number of transmission attempts Nattempt and the number of successful transmissions Nsuc, or the first predetermined number of successful data transmissions, during each sampling period are counted, from which the transmission success probability is determined as p_{suci}=Nattempt/Nsuc. The average transmission rate may be determined by averaging over all transmission attempts. The utility measure for a sampling period may be calculated using the average transmission rate, the estimated transmission success probability p_{succi} and the chosen carrier sense threshold.

The “interference range” IR may be defined as the maximum distance between two stations such that, when one of them transmits, the other station will be affected (e.g., transmission attempts at a chosen rate cannot be successful). The transmitter 102 may include an SINR required by the highest transmission rate, SINRmax. Then, the interference range IR may have a maximum value R*(1+6*SINRₘₐₓ^{1/θ}) where R is the maximum transmission range.

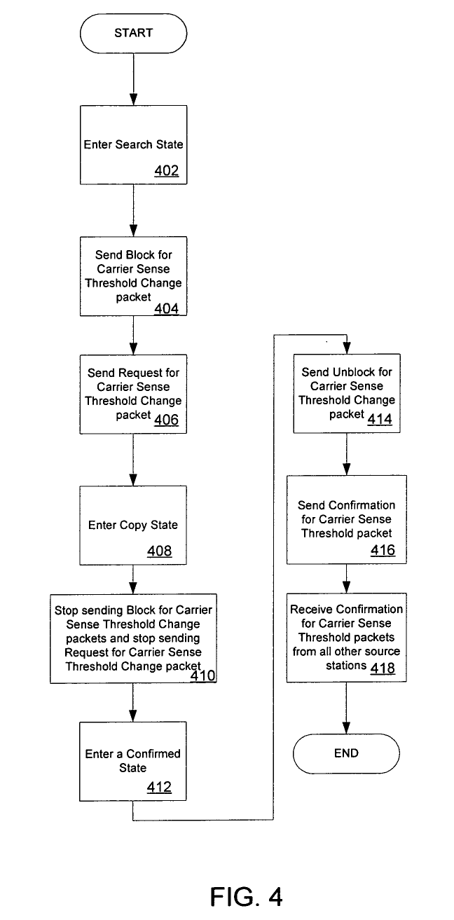

FIG. 4 illustrates a flow diagram for the states of operation of the transmitter 102. Each source station, such as transmitter 102, may be in three different states: A Search State, A Confirmed State and A Copy State. A transmitter 102 may enter into a Search State (Act 402) if it needs to search for the carrier sense threshold and transmission rate operating point. Once in the Search State, the transmitter 102 may periodically send a Block for Carrier Sense Threshold Change packet (BCSTC) (Act 404), followed by sending a Request for Carrier Sense Threshold Change packet (RCSTC) via the second radio (Act 406). The stations that receive either BCSTC or RCSTC packet may enter Copy State, and the stations that receive RCSTC packets may be required to use the carrier sense threshold included in the RCSTC packets. The transmission range of RCSTC should be at least the interference range (i.e., ≧IR) so that all interfering stations may be informed of the carrier sense threshold currently used by the transmitter 102. The transmission range of BCSTC may be required to be at least two times the interference range (i.e., ≧2*IR).

One searching station may survive within the transmission range of BCSTC packets. If two transmitters 202 and 206 begin to send BCSTC packets simultaneously, neither of them can receive BCSTC correctly. The competition is resolved when a BCSTC packet from one transmitter 202 is sent earlier than that of transmitter 206. After receiving the BCSTC packet from transmitter 202, transmitter 206 may enter a Copy State (Act 408) and stop sending BCSTC packets (Act 410).

To evaluate a carrier sense threshold, the searching station may determine the transmission success probability p_{suc} and the average transmission rate for each sampling period. The p_{suc} and the transmission rate may be averaged over multiple sampling periods in order to minimize the impact of random noise. A utility measure for this carrier sense threshold is obtained based the process illustrated in FIG. 3. A comparison may be performed by evaluating all choices of carrier sense threshold. The carrier sense threshold generating the highest utility will be the searching station's best choice cs_{best}. The transmitter 102 may require a period of time to approach a suitable value after the carrier sense threshold has been changed. Therefore, p_{suc} and transmission rate may be measured after this transition time has passed.

Once the searching phase has been completed, the transmitter 102 may enter a Confirmed State (Act 412) and may periodically send a Unblock for Carrier Sense Threshold Change packet (UCSTC) (Act 414), followed by sending a Confirmation for Carrier Sense Threshold packet (CCST) on the second radio (Act 416). The transmission range for UCSTC packets may be at least two times the interference range (i.e., ≧2*IR) and the transmission range for CCST packets may be at least the interference range (i.e., ≧IR). CCST packets from transmitter 102 may be responsible for announcing the carrier sense threshold cs_{best}. A transmitter 102 may receive CCST packets from all other source stations within its interference range after their searching phases have been completed, and the transmitter 102 may learn about other station's choices of cs_{best} (Act 418).

If a transmitter 102 chooses a large carrier sense threshold, the transmitter 102 may transmit more aggressively, which may cause performance loss to the entire network as the aggressive station occupies the shared channel resource and interferes with other transmissions. For a transmitter 102 in the Confirmed State, the transmitter 102 may use the minimum value among all cs_{best} that the transmitter 102 is aware of, including its own cs_{best}, as the transmitter 102 carrier sense threshold (Act 420).

When a transmitter 102 receives either BCSTC or RCSTC packets, it may enter A Copy State, if it is not already in, and remember its previous state (Act 422). A transmitter 102 in Copy State may be required to use whatever carrier sense threshold is included in the received RCSTC packets. While in the Copy State, the transmitter 102 may maintain the number of searching stations Nsearch that it has heard from. Nsearch may be increased by one whenever a new searching station is heard from, and Nsearch will be decreased by one when a UCSTC or CCST packet from a previously heard searching station is received (Act 424). A transmitter 102 in A Copy State may return back to its previous state when Nsearch is reduced to zero (Act 426). A releasing timer may be used to impose a maximum duration in which a source station may stay in the Copy State to account for transmission errors.

As long as the network topology and traffic pattern do not change, the cs_{best} chosen by each source station may remain the same. Additionally, since cs_{best} chosen by a searching station is the one that maximizes its utility when all interfering stations use the same carrier sense threshold, cs_{best} is optimal.

Dynamic Spatial Backoff Algorithm

The utility-based spatial backoff algorithm illustrated in FIG. 3 may ensure the stability and non-starvation of the network 100. The process may require a level of coordination among interfering stations, which may be enabled by using a second radio with larger transmission range. The performance of a dynamic algorithm may suffer if a transmitter 102 has to probe many possible operating points and a large fraction of them are not desired ones. A dynamic spatial backoff method may reduce the search space for the carrier sense threshold and transmission rate operating points. Instead of trying many possible choices of carrier sense threshold, the method may specify a corresponding carrier sense threshold for each transmission rate that a wireless transceiver.

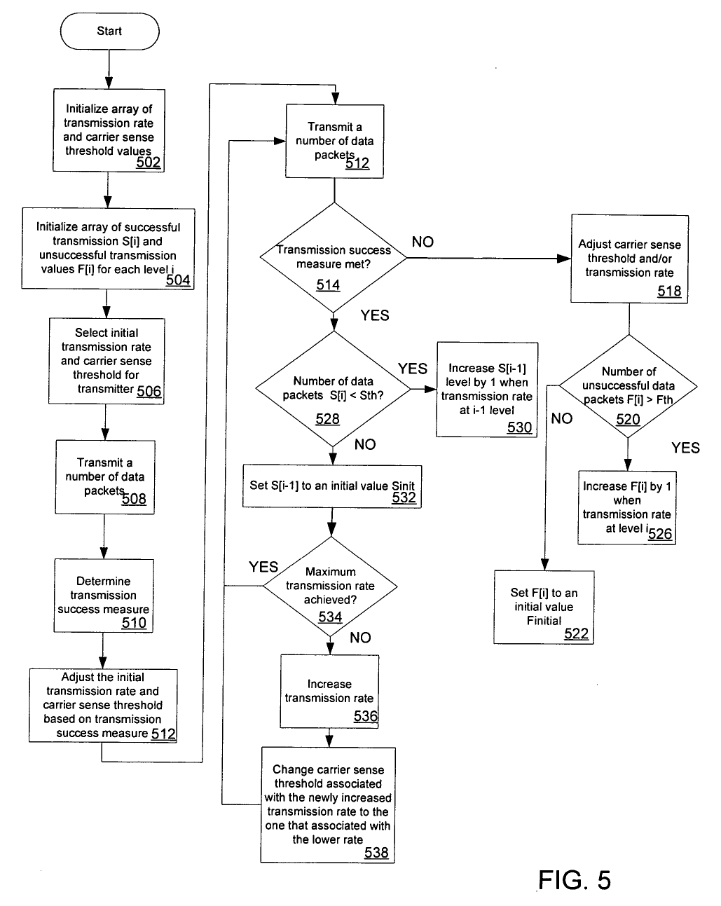

FIG. 5 illustrates acts taken to dynamically resolve contention in a wireless network. The transmitter 102 may initialize an array of carrier sense threshold parameters associated with a transmitter station, where an element of the array of carrier sense threshold parameters is associated with an element of the array of transmission rate parameters (Act 502). The transmitter 102 may support K levels of transmission rates which may be represented using an array Rate[ ] and where Rate[j]<Rate[i] if j<i (i, jε[1, . . . , K]). The transmitter 102 may support K carrier sense threshold values, which may be represented using the array CS[ ]. For a transmission rate Rate[i], an associated carrier sense threshold may be CS[i]. The transmitter 102 may initialize CS[ ] such that CS[j]>CS[i] if i≧j (i, jε[1, . . . , K]) since a higher transmission rate may tolerate less interference.

The transmitter 102 may initialize an array of successful transmission values S[i] for each transmission rate level i, and an array of unsuccessful transmission values F[i] for each transmission rate level i (Act 504). The transmitter 102 selects an initial transmission rate and an initial carrier sense threshold (Act 506). The transmitter 102 may select the lowest transmission rate supported by the transmitter 102. The transmitter 102 may select the largest carrier sense threshold support by the transmitter 102, corresponding to the lowest transmission rate.

The transmitter 102 transmits one or more data packets using the selected initial transmission rate and selected initial carrier sense threshold (Act 508). The transmitter 102 determines a transmission success parameter based on the transmitted data packets and the arrays S[ ] and F[ ] of successful and unsuccessful transmission values (Act 510). Based on the transmission success parameter, the transmitter 102 adjusts the initial transmission rate and the initial carrier sense threshold based on the transmission success parameter (Act 512).

The transmitter 102 may determine the transmission success measure by determining at least one of a predetermined number of successful data packet transmissions S[i] related to the integer value i of the transmission rate level or a predetermined number of unsuccessful data packet transmissions F[i] related to the integer value i of the transmission rate level.

A transmitter 102 starts from the lowest transmission rate and the largest carrier sense threshold (i.e., Rindex=1 and CSi [Rindex]=1. When transmitting at rate Rate[Rindex], if the transmitter 102 has transmitted successfully according to some transmission success parameter, such as S[Rindex] consecutive successful transmissions, the transmitter 102 increases its transmission rate by one level (i.e, Rindex=Rindex+1) until the highest supported transmission rate has been reached. After that, the current carrier sense threshold will be associated with the new transmission rate (i.e., CSi [Rindex]=CSi [Rindex−1])

To adjust carrier sense threshold and transmission rate to improve the aggregate throughput, a source station encountering transmission failures can take the following actions to improve the situation: transmit at a lower rate and possibly use a larger CS threshold; or transmit more conservatively by using a smaller carrier sense threshold.

Successful transmissions may imply the following two possibilities for a source station: a higher transmission rate may be supported; or more interference can be tolerated at the receiver. Successful transmissions indicate that the interference is small enough for the SINR threshold of current rate to be satisfied. If the interference is sufficiently small, it is possible for SINR requirements of higher rates to be met as well. The transmitter 102 may transmit more aggressively by increasing the carrier sense threshold. The transmitter 102 may increase the transmission rate Rate[i] up to a maximum transmission rate Rate[K] supported by the transmitter 102. The transmitter 102 may transmit more aggressively by increasing the CS threshold. If a transmitter 102 increases its carrier sense threshold, the transmitter 102 that has been successful will become more and more aggressive and consume more and more channel resource. If the transmitter 102 encountering transmission failures decreases its carrier sense threshold, it will become more and more conservative and lose its chances to access the channel. Starvation for the transmitter 102 may occur. In the dynamic spatial backoff method illustrated in FIG. 5, transmitter 102 may increase its transmission rate and decrease its carrier sense threshold upon successful transmissions; and the transmitter 102 decreases its transmission rate and increase its carrier sense threshold upon failures. When reducing the transmission rate, the required SINR decreases and more interference may be tolerated at the receiver. By increasing the carrier sense threshold accompanying the decrease of transmission rate, two benefits may be obtained. The first benefit comes from the reduced contending area around the source station, which will help to reduce the collision probability. The second benefit is due to the improved spatial reuse since a larger carrier sense threshold enables the station to transmit more aggressively. Through the dynamic adjustment of carrier sense threshold and transmission rate, a smaller contending area may result (thus, fewer collisions and more concurrent transmissions) and a lower transmission rate may result when the channel contention is severe. When the channel contention is less, a higher transmission rate may result and possibly a smaller number of concurrent transmissions.

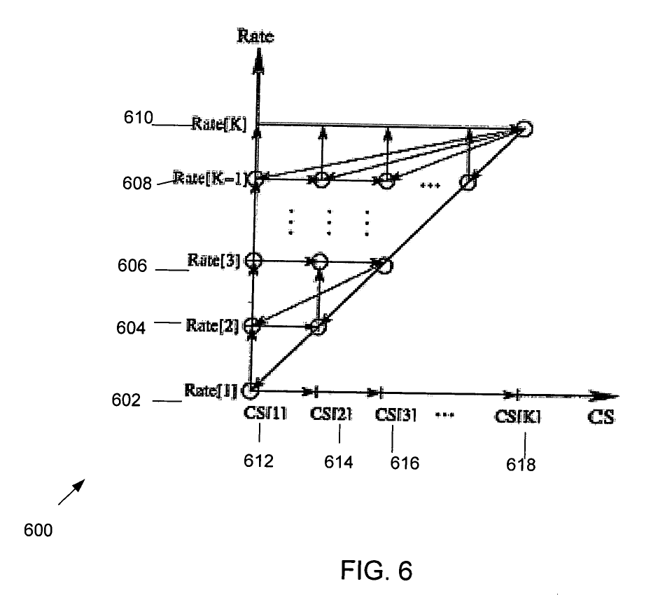

FIG. 6 illustrates the values that the transmission rate Rate[i] and the carrier sense threshold CS[i] may take on during operation of the transmitter 102. Rate[i] may take on a number of discrete transmission level values Rate[1], Rate[2], Rate[3], . . . . Rate[K−1], and Rate[K] (602, 604, 606, 608, 610). At each transmission rate level i, the carrier sense threshold may take on values CS[1], CS[2], CS[3] . . . CS[K] (612, 614, 616, 618). At each transmission rate level i, the carrier sense threshold index value CSi[Rindex] is constrainted to be less than the level represented by i. For example, at Rate[3], the level of the carrier sense threshold may take on values associated with array indices less than 3. The carrier sense threshold values CS[1], CS[2], CS[3] . . . CS[K] (612, 614, 616, 618) are ordered in a decreasing sequence, such that CS[1] is the largest carrier sense threshold for a given transmission rate level Rate[i]. In a general network, different stations may have different levels of channel contention, depending on their locations, so each transmitter 102 may adjust the value of CSi [Rindex], under the constraint that CSi[Rindex]<Rindex, where Rindex is the transmission rate level selected by the transmitter 102. For a transmission rate Rate[Rindex], a station may use a carrier sense threshold larger than or equal to CS[Rindex].

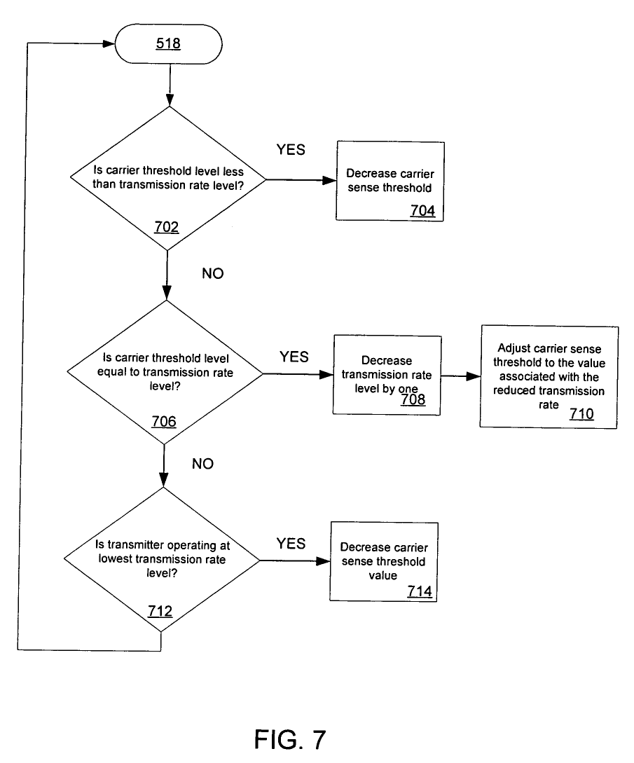

The transmitter 102 transmits a number of data packets (Act 512). The transmitter 102 determines if the transmissions are considered successful according to some transmission success parameter, such as a minimum number of consecutive data packets S[i] for a given transmission rate level i have been received by a receiver station (Act 514). If the transmission success parameter has been met, the transmitter 102 adjusts the carrier sense threshold and/or the transmission rate (Act 518), which is illustrated in FIG. 7.

FIG. 7 illustrates the process of block 518 in detail. The transmitter 102 determines if the carrier sense threshold for the associated transmission rate level is less than the index level (i.e., CSi[Rindex]<Rindex) (Act 702). If CSi[Rindex]<Rindex, then the transmitter 102 decreases the carrier sense threshold associated with current transmission rate (i.e., CSi [Rindex]=CSi [Rindex]+1) (Act 704). In the situation where there are a minimum number of unsuccessful transmissions, the transmission rate used by the station may have been increased too high to be afforded by its current carrier sense threshold. By reducing the carrier sense threshold, the station may transmit more conservatively, which may help the station to improve its transmission success probability at current rate.

If the transmitter 102 determines that the carrier sense threshold is equal to the carrier sense threshold level of the transmission rate index (i.e., CSi [Rindex]=Rindex) (Act 706), then the station decreases its transmission rate by one level (i.e., Rindex=Rindex−1) (Act 708) and the transmitter 102 adopts the carrier sense threshold associated with the lower transmission rate (Act 710). If the transmitter 102 fails at the transmission rate Rindex when using CSi[Rindex] as the carrier sense threshold, the surrounding interference may be too high to support the current transmission rate. By reducing the transmission rate, more interference may be tolerated at the receiver.

If the transmitter 102 determines that transmission failures occur when transmitting at the lowest rate (i.e., Rindex=1) (Act 712), then the carrier sense threshold associated with the lowest rate will be decreased (i.e., CSi [Rindex]=CSi [Rindex]+1) (Act 714). If transmission failures at the lowest rate occur, the interference at the receiver may be so high that even the SINR requirement of the lowest rate cannot be satisfied. The transmitter 102 may improve the situation by decreasing its carrier sense threshold.

When probing a small carrier sense threshold, a transmitter 102 may become so conservative that it no longer has enough chances to access the channel. The transmission failures of a station may not be observed if the station does not transmit at all. As a result, a small carrier sense threshold value may be retained and the station may lose its chance to access the channel. To compensate for this situation, the transmitter 102 may determine if a data packet transmission attempt has been made during a sampling time period. The transmitter 102 may decrease the transmission rate if no data packet transmission attempts have been made during the sampling time period, and may adjust the carrier sense threshold to a carrier sense threshold associated with the decreased transmission rate.

To avoid the performance loss due to frequent unsuccessful probing, the transmitter 102 may dynamically adjust the values of the predetermined number of successful data packet transmissions S[ ] and the predetermined number of unsuccessful data packet transmissions F[ ]. The transmitter 102 determines if the total number of successful transmissions at rate level Rindex, is more than a threshold Fth (Act 520). If F[Rindex]>Fth, then F[Rindex] will be increased by 1 when the station returns to the lower transmission rate (i.e., F[Rindex]=F[Rindex]+1) (Act 526). If F[Rindex]<Fth, the transmitter 102 resets the value of F[Rindex] to an initial value Finital (Act 522).

The transmitter 102 determines if the total number of successful transmissions at transmission rate level Rindex (i.e., S[Rindex]) is less than a successful transmission value Sth (Act 528). If S[Rindex]>Sth, the transmitter 102 increases the predetermined number of successful data transmissions for the next lower level (i.e. S[Rindex−1] by 1 when the station returns to the rate level Rindex−1 (i.e., S[Rindex 1]=S[Rindex−1]+1) (Act 530). If S[Rindex]<Sth, the transmitter 102 adjusts the predetermined number of successful data packet transmissions at the next lower level (i.e., S[i−1]) to an initial value Sinit.

The transmitter 102 determines if the maximum transmission rate has been achieved (Act 534). If the maximum transmission rate has not been achieved, the transmitter 102 will increase the transmission rate if there have been a predetermined number of successful data packet transmissions (Act 536), and adjust the carrier sense threshold to a carrier sense threshold associated with the new transmission rate (Act 538). If the maximum transmission rate has been achieved, the transmitter 102 will return to block 512 and repeat the steps in the process.

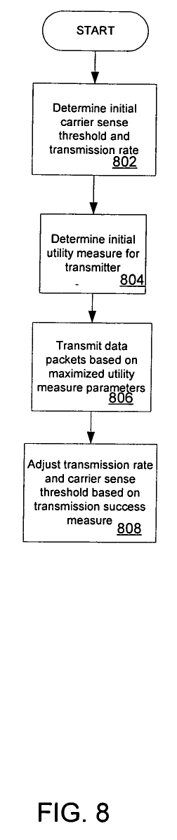

FIG. 8 illustrates acts taken to dynamically resolve network contention using both the utility-based spatial back-up process and the dynamic spatial back-off process. The transmitter 102 determines a plurality of initial transmitter parameters, such as a carrier sense threshold and a transmission rate (Act 802). The transmitter 102 may determine the parameters using predetermined values or may load the parameters at a start-up phase, or may be configured during operation. The transmitter 102 determines a utility measure of a wireless transmitter station related to the plurality of initial transmitter station parameters (Act 804). The transmitter 102 may use a utility measure such as that defined in Equation 1 above:
Uᵢ=rateᵢ*csᵢ^{2/θ}*p_{suc}_{ᵢ}

where rateᵢ is the transmission rate, csᵢ is the carrier sense threshold used by station i, and P_{suci} is a transmission success probability, given the chosen csᵢ and Rindex

The transmitter 102 determines a transmission rate and a carrier sense threshold, where the transmission and the carrier sense threshold maximize the utility measure. The transmitter may perform acts such as those illustrated in FIG. 3 to determine the transmission rate and/or carrier sense threshold. The transmitter 102 transmits a data signal based on the transmission rate and the carrier sense threshold which maximized the utility measure in block 804 (Act 806). The transmitter 102 then adjusts at least one of the transmission rate and the carrier sense threshold based on at least one of a successful transmission measure or an unsuccessful transmission measure (Act 808). The transmitter 102 may adjust the transmission rate and the carrier sense threshold based on the process illustrated in FIGS. 5 and 7.

A transmitter may converge to a point with the largest possible transmission rate and its corresponding carrier sense threshold, at which the transmitter may transmit successfully with a high probability. If a transmitter operates at a place below its desired point on the two-dimensional rate and carrier sense threshold space, as illustrated in FIG. 6, a transmitter will transmit at a lower rate using a larger or equal carrier sense threshold. The transmitter may transmit successfully with high probability and it may increase its transmission rate and move up along the space. If a transmitter operates at a place above an optimal point, it may transmit at a higher rate using a smaller or equal carrier sense threshold. The transmitter may either fail frequently or may be deprived of chances to access the channel. The source station will decrease its transmission rate and move down along the space.

Like the methods shown in FIGS. 4-6, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the transmitter 102, a communication interface, or any other type of non-volatile or volatile memory interfaced or resident to the transmitter 102. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for resolving network contention in a wireless network, comprising more than one transmitter stations, comprising:
determining a plurality of initial transmitter station parameters;
determining an initial utility measure of a wireless transmitter station related to the plurality of initial transmitter station parameters;
adjusting, during a sampling period, a first transmitter parameter and a second transmitter parameter of the plurality of initial transmitter station parameters;
determining a final utility measure related to the adjusted first and second transmitter parameters;
transmitting a data stream based on the initial transmitter station parameters if the initial utility measure if greater than the final utility measure; and
transmitting a data stream based on the final transmitter station parameters if the final utility measure is greater than the initial utility measure.

2. The method of claim 1 where adjusting the first transmitter parameter comprises adjusting a carrier sense threshold related to the transmitter station.

3. The method of claim 2 where adjusting the second transmitter parameter comprises adjusting a transmission rate related to the transmitter station.

4. The method of claim 1 where comparing the initial utility measure to the final utility measure comprises comparing the initial utility measure to the final utility measure after more than one sampling period.

5. The method of claim 3 further comprising performing a rate control procedure.

6. The method of claim 5 where performing a rate control procedure comprises performing an automatic rate fallback procedure.

7. The method of claim 5 where performing a rate control procedure comprises:
determining if a first predetermined number of consecutive data packet transmissions are successful;
determining if a second predetermined number of consecutive data packet transmissions are unsuccessful;
increasing, during the sampling period, the transmission rate by a predetermined rate level if the first predetermined number of data packet transmissions are successful; and
decreasing, during the sampling period, the transmission rate by the predetermined rate level if the second predetermined number of data packet transmissions are unsuccessful.

8. The method of claim 7 where increasing comprises increasing the transmission rate up to no more than a maximum station transmission rate.

9. The method of claim 7 where decreasing comprises decreasing the transmission rate down to no less than a minimum station transmission rate.

10. The method of claim 7 further comprising copying, to one or more interfering stations, the carrier sense threshold determined by the transmitter station.

11. The method of claim 7 where determining if a first predetermined number of consecutive data packet transmissions are successful comprises utilizing a MAC layer acknowledgement procedure.

12. The method of claim 7 where determining if a second predetermined number of data packet transmissions are unsuccessful comprises utilizing a MAC layer acknowledgement procedure.

13. The method of claim 10 where copying, to one or more interfering stations, the carrier sense threshold determined by the transmitter station comprises:
initializing a second radio transmitter associated with the transmitter station;
transmitting by the second radio transmitter the carrier sense threshold to the one or more interfering stations, where a transmission range of the second radio transmitter comprises a distance at least as far as a distance of a farthest interfering station from the transmitting station;
adopting the carrier sense threshold transmitted by the second radio transmitter by the one or more interfering stations.

14. A method for resolving a contention in a wireless network comprising:
initializing an array of transmission rate parameters associated with a transmitter station;
initializing an array of carrier sense threshold parameters associated with a transmitter station, where an element of the array of carrier sense threshold parameters is associated with an element of the array of transmission rate parameters;
selecting an initial transmission rate and an initial carrier sense threshold;
transmitting one or more data packets using the selected initial transmission rate and selected initial carrier sense threshold;
determining a transmission success parameter; and
adjusting the initial transmission rate and the initial carrier sense threshold based on the transmission success parameter.

15. The method of claim 14 where initializing the array of carrier sense threshold parameters comprises indexing a list of carrier sense threshold values related to an integer value, where the element of the array of carrier sense threshold values associated with the integer value represents a carrier threshold level.

16. The method of claim 15 where initializing the array of transmission rate parameters comprises indexing a list of transmission rate values related to an integer value, where the element of the array of transmission rate values associated with the integer value represents a transmission rate level.

17. The method of claim 16 where selecting comprises:
selecting a lowest transmission rate from the array of transmission rate parameters; and
selecting a highest carrier sense threshold from the array of carrier sense threshold parameters.

18. The method of claim 17 where determining a transmission success parameter comprises determining at least one of a predetermined number of consecutive successful data packet transmissions related to the integer value of the transmission rate level or a predetermined number of consecutive unsuccessful data packet transmissions related to the integer value of the transmission rate level.

19. The method of claim 18 where determining a predetermined number of consecutive successful data packet transmissions comprises utilizing a MAC layer acknowledgement procedure.

20. The method of claim 18 where determining the predetermined number of unsuccessful data packet transmissions comprises utilizing a MAC layer acknowledgement procedure.

21. The method of claim 19 where adjusting the initial transmission rate and the initial carrier sense threshold based on the transmission success parameter comprises:
increasing the transmission rate, where the transmission rate is less than or equal to a maximum transmission rate associated with the transmitter station; and
setting a carrier sense threshold of the transmitter to the carrier sense threshold associated with the increased transmission rate of the transmitter station.

22. The method of claim 20 where adjusting the initial transmission rate and the initial carrier sense threshold based on the transmission success parameter comprises:
reducing a carrier sense threshold associated with the adjusted transmission rate to a next lower carrier sense threshold value if the carrier sense threshold level associated with the transmission rate is less than the transmission rate level.

22. The method of claim 20 where adjusting the initial transmission rate and the initial carrier sense threshold based on the transmission success parameter comprises:
decreasing the transmission rate by one transmission rate level if the carrier sense threshold level associated with the transmission rate is equal to the transmission rate level; and
adjusting the carrier sense threshold to a carrier sense threshold associated with the decreased transmission rate level.

24. The method of claim 20 where adjusting the initial transmission rate and the initial carrier sense threshold based on the transmission success parameter comprises:
decreasing the carrier sense threshold associated with a lowest transmission rate level if the transmitter station is using the lowest transmission rate.

25. The method of claim 18 further comprising:
determining if a data packet transmission attempt has been made during a sampling time period;
decreasing the transmission rate of the transmitter station if no data packet transmission attempts have been made during the sampling time period; and
adjusting the carrier sense threshold to a carrier sense threshold associated with the decreased transmission rate.

26. The method of claim 19 further comprising:
determining an array of successful transmission values associated with levels of transmission rates of the transmitter station, where the array is ordered sequentially and an element of the array is related to a transmission rate level;
determining a threshold value of successful transmissions related to an element of the array;
increasing, when the transmitter station changes its transmission level to one level below the selected transmission rate, an element of the successful transmission array related to a lower level of the transmission array if the total number of successful data packet transmissions at the selected transmission level is less than the threshold value of successful data packet transmissions; and
increasing the element of the unsuccessful transmission array related to the selected transmission rate when the transmitter station reduces its rate to a lower level, if the total number of successful transmissions at the selected transmission rate is more than a threshold value.

27. The method of claim 20 further comprising:
determining an array of unsuccessful transmission values associated with levels of transmission rates of the transmitter station, where the array is ordered sequentially and an element of the array is related to a transmission rate level;
determining a threshold value of unsuccessful transmissions related to an element of the array;
increasing the unsuccessful transmission rate value associated with a transmission rate lower than the selected transmission rate when the transmitter station transmits at the lower transmission rate, if a number of successful transmissions at the selected transmission rate is more than the threshold value of unsuccessful transmissions; and
adjusting a element of the unsuccessful transmission values related to the selected transmission rate to an initial value if the total number of successful data packet transmissions at the selected transmission rate is less than a threshold value

28. A method for dynamically resolving network contention in a wireless network, comprising more than one transmitter stations, comprising:
determining a plurality of initial transmitter station parameters;
determining a utility measure of a wireless transmitter station related to the plurality of initial transmitter station parameters;
determining a transmission rate and a carrier sense threshold, where the transmission and the carrier sense threshold maximize the utility measure;
transmitting a data signal based on the transmission rate and the carrier sense threshold; and
adjusting at least one of the transmission rate and the carrier sense threshold based on at least one of a successful transmission measure or an unsuccessful transmission measure.
